(19) United States
(12) Patent Application Publication
(10) Pub. No.: US 2017/0023133 A1
(43) Pub. Date: Jan. 26, 2017

(54) SHIFT RANGE SWITCHOVER CONTROL APPARATUS

(71) Applicant: DENSO CORPORATION, Kariya-city (JP)

(72) Inventor: Jun TARUI, Kariya-city (JP)

(21) Appl. No.: 15/204,201

(22) Filed: Jul. 7, 2016

(30) Foreign Application Priority Data
Jul. 25, 2015 (JP) 2015-147284

(51) Int. Cl. F16H 61/32; H02P 25/08

(52) U.S. Cl. CPC F16H 61/32; H02P 25/08

(57) ABSTRACT

A microcomputer rotationally drives a motor by executing an encoder-synchronized control to sequentially switch over a current supply phase of the motor in synchronization with an output signal of the encoder. The microcomputer checks whether the motor stagnates to rotate after a start of the encoder-synchronized control. The microcomputer rotationally drives the motor by switching over from the encoder-synchronized control to a time-synchronized control to sequentially switch over the current supply phase of the motor in synchronization with a predetermined time, when the motor is determined as failing to rotate. The microcomputer thus rotationally drives the motor quickly by the time-synchronized control even when the motor fails to rotate because of delay in a switchover time of the current supply phase after the switchover of the encoder-synchronized control.

### CROSS REFERENCE TO RELATED APPLICATION

The present application is based on Japanese patent application No. 2015-147284, filed on Jul. 25, 2015, the content of which is incorporated herein by reference.

### TECHNICAL FIELD

The present disclosure relates to a shift range switchover control apparatus, which switches over a shift range of a transmission by using a motor as a driving power source.

### BACKGROUND ART

In recent years, more and more vehicles change mechanical driving systems to electrical driving systems, which use motors, to save installation spaces, improve assembling work and enhance control performance. As one example, JP 3,800,529 discloses a system, which drives a shift range switchover mechanism of an automatic transmission of a vehicle by a motor. This system includes an encoder, which outputs a pulse signal at every angular rotation in synchronization with motor rotation, and rotationally drives the motor by sequentially switching over a current supply phase of the motor in correspondence to a count value of the output signal of the encoder.

According to the system described above, an encoder-synchronized control, which is a rotation-synchronized control, is executed to switch over the current supply phase of the motor in response to the output signal of the encoder for rotationally driving the motor. In the encoder-synchronized control, the current supply phase of the motor is switched over in response to the output signal of the encoder so that a driving torque larger than a load torque is generated by sequentially switching over the current supply phase at appropriate timing, which corresponds to a rotation position (rotation angle) of a rotor of the motor.

However, the rotor rotation position of the motor and the signal output timing of the encoder occasionally deviate each other because of individual system difference (manufacturing tolerance), aging change and the like. In the encoder-synchronized control, a deviation of the switchover timing of the current supply phase increases as the deviation of the signal output timing of the encoder relative to the rotation position of the rotor increases. As a result, the driving torque of the motor may decrease to be smaller than the load torque. When the driving torque of the motor decreases to be smaller than the load torque, the motor may not be rotationally driven thus causing stagnation in the rotation of the motor. When the motor rotation is disabled by stagnation, the output signal of the encoder is not updated and the current supply phase is not switched over for further rotation. As a result, reliability of the system operation is lowered.

### SUMMARY

The present disclosure has an object to provide a shift range switchover control apparatus, which is capable of rotationally driving the motor speedily and thereby improving reliability of a system operation even in a case that a deviation of a switchover timing of a current supply phase, that is, a deviation of a signal output timing of an encoder, causes a stagnation of motor rotation after a start of an encoder-synchronized current supply phase control.

In one aspect, a shift range switchover control apparatus for a transmission of a vehicle comprises a shift range switchover mechanism including a motor as a driving power source for switching over a shift range of the transmission, an encoder for outputting a pulse signal in synchronization with a rotation of the motor, a power supply control part for rotationally driving the motor by executing an encoder-synchronized control to sequentially switch over a current supply phase of the motor in synchronization with an output signal of the encoder, and a check part for checking whether the motor is in stagnation in rotation after a start of the encoder-synchronized control. The power supply control part rotationally drives the motor by switching over from the encoder-synchronized control to a time-synchronized control to sequentially switch over the current supply phase of the motor in synchronization with a predetermined time, when the check part determines that the motor is in the stagnation.

Preferably, the power supply control part starts the time-synchronized control by returning a current supply phase of the motor to a previous current supply phase, to which the current was supplied last, at time of switching over from the encoder-synchronized control to the time-synchronized control.

### BRIEF DESCRIPTION OF THE DRAWINGS

FIG. 1 is a perspective schematic view showing a shift range switchover mechanism in one embodiment of a shift range switchover control system;

FIG. 2 is a block diagram showing a shift range switchover control system;

FIG. 3 is a time chart showing a change in a driving torque in a case of a small deviation of a switchover timing of a current supply phase in an encoder-synchronized control;

FIG. 4 is a time chart showing a change in a driving torque in a case of a large deviation of a switchover timing of a current supply phase in an encoder-synchronized control;

FIG. 5 is a time chart showing an example of a current supply control performed in the embodiment;

FIG. 6 is a flowchart showing processing of an encoder interrupt routine executed in the embodiment; and

FIG. 7 is a flowchart showing processing of a current supply control routine executed in the embodiment.

### EMBODIMENT

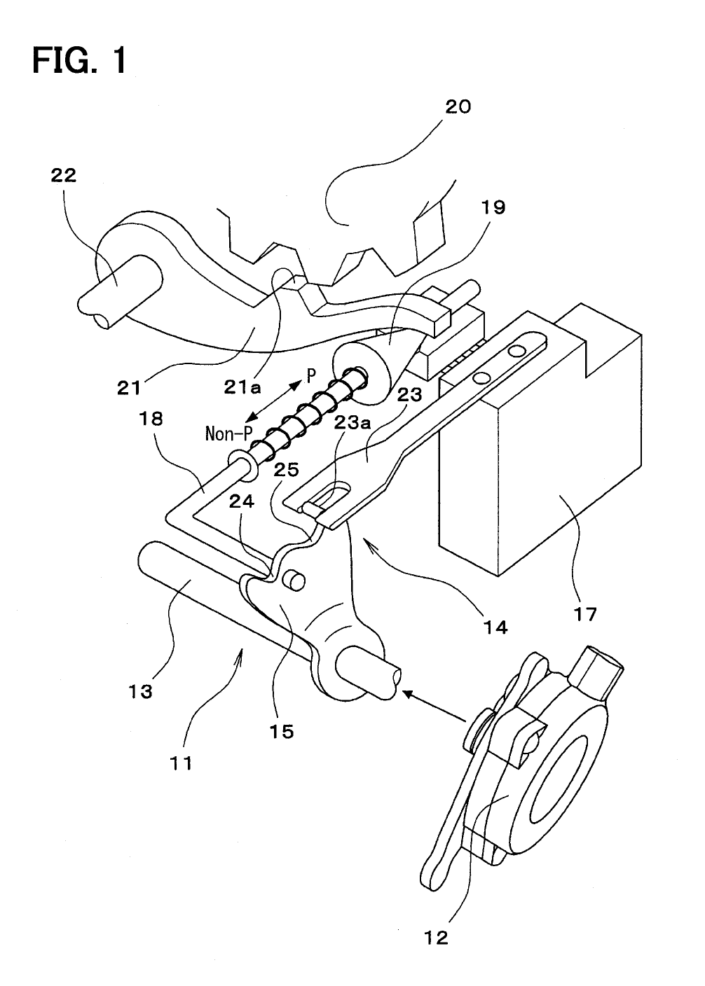

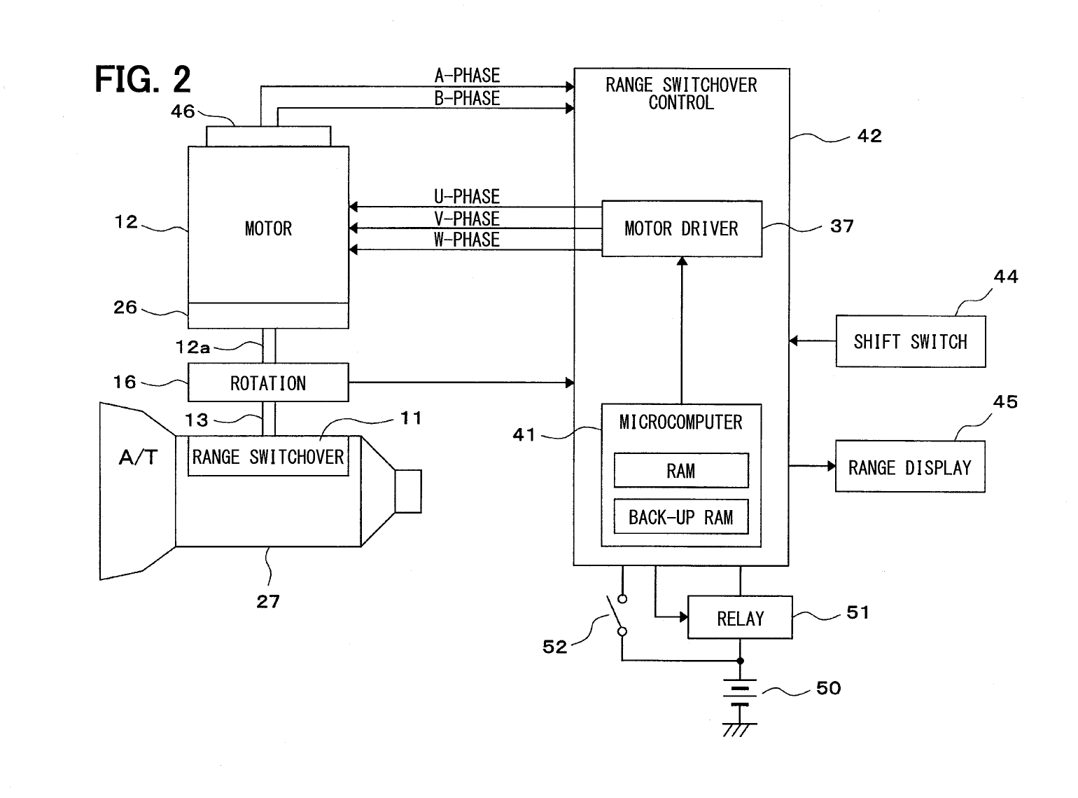

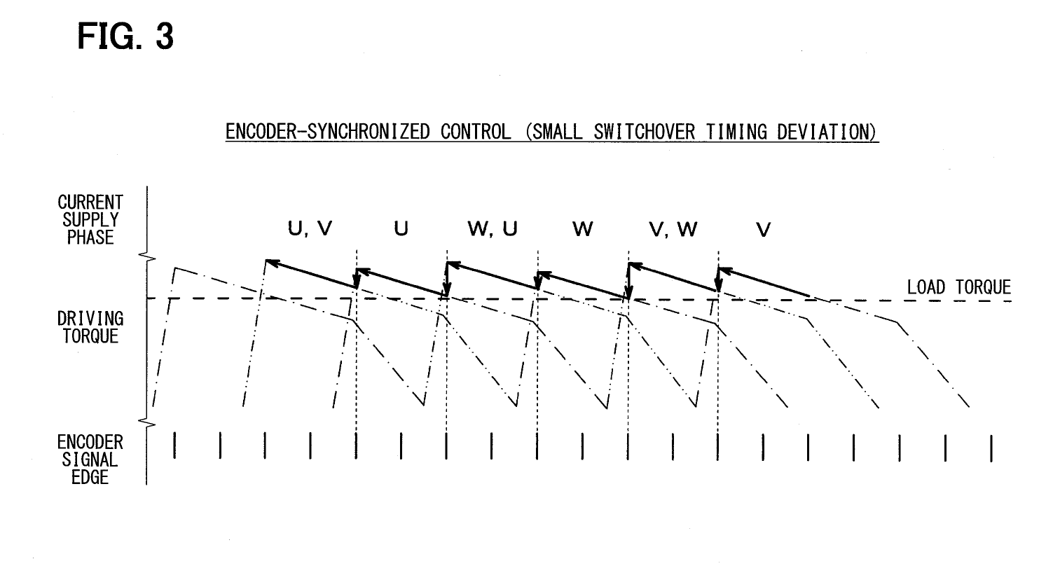

Referring first to FIG. 1 and FIG. 2 showing a shift range switchover control system, a shift range switchover mechanism 11 of the shift range switchover control system is configured as a two-position shift range switchover mechanism, which switches over a shift range of an automatic transmission 27 of a vehicle between a parking range (P-range) and a non-parking range (Non-P-range). The shift range switchover mechanism 11 uses as its driving power source an electric motor 12, which is for example a switched reluctance motor. The motor 12 has a reduction mechanism 26 therein and an output shaft 12a. A manual shaft 13 is coupled to the output shaft 12a of the motor 12. A detent lever 15 is fixed to the manual shaft 13.

A manual valve (not shown) is coupled to the detent lever 15 to move linearly in correspondence to rotation of the detent lever 15. The manual valve is provided to switch over a hydraulic pressure circuit (not shown) in the automatic transmission 27 for switching over a shift range of the transmission 27.

An L-shaped parking rod 18 is fixed to the detent lever 15. A conical body 19 provided at a top end of the parking rod 18 contacts a lock lever 21. The lock lever 21 moves up and down about a shaft 22 in correspondence to a position of the conical body 19 to lock and unlock a parking gear 20. The parking gear 20 is provided about the output shaft of the automatic transmission 27. When the parking gear 20 is locked by the lock lever 21, drive wheels of a vehicle are held in a rotation-stop state (parking state).

A detent spring 23 is fixed to a support base 17 for holding the detent lever 15 in each of shift ranges P and Non-P. The detent lever 15 is formed a

P-range holding recess 24 and a Non-P-range holding recess 25 in correspondence to the shift ranges P and Non-P, respectively. When an engagement member 23a provided at the top end of the detent spring 23 falls to fit in the P-range holding recess 24 of the detent lever 15, the detent lever 15 is held in the P-range position. When the engagement member 23a falls to fit in the Non-P-range holding recess 25 of the detent lever 15, the detent lever 15 is held in the Non-P-range position. The detent lever 15 and the detent spring 23 form a detent mechanism 14, which engages and holds a rotation position of the detent lever 15 in the corresponding one of positions of the shift ranges, that is, holds the shift range switchover mechanism 11 in corresponding one of positions of the shift ranges.

In the P-range, the parking rod 18 is moved in a direction to approach the lock lever 21 so that a large-diameter part of the conical body 19 lifts the lock lever 21 to fit a protrusion 21a of the lock lever 21 in the parking gear 20 and lock the parking gear 20. Thus the output shaft of the automatic transmission 27 coupled to the drive wheels of the vehicle is held in the locked state, that is, in the parking state.

In the Non-P-range, the parking rod 18 is moved in a direction leaving away from the lock lever 21, the large-diameter part of the conical body 19 is pulled out of the lock lever 21 to lower the lock lever 21. Thus, the protrusion 21a of the lock lever 211s disengaged from the parking gear 20 and the parking gear 20 is unlocked. As a result, the output shaft of the automatic transmission 27 is held in a rotatable state, that is, in a vehicle travel state.

As shown in FIG. 2, a rotation sensor 16 is provided on the manual shaft 13 of the shift range switchover mechanism 11 for detecting a rotation angle (rotation position) of the manual shaft 13. The rotation sensor 16 is formed of a sensor, for example, a potentiometer, which outputs a voltage corresponding to a rotation angle of the manual shaft 13. It is thus possible to confirm whether the actual shift range is the P-range or the Non-P-range based on the output voltage of the rotation sensor.

As shown in FIG. 2, the motor 12 is provided with an encoder 46, which detects a rotation angle (rotation position) of a rotor of the motor 12. The encoder 46 may be magnetic rotary-type encoder. The encoder 46 is configured to output pulse signals of A-phase and B-phase in synchronism with a rotation of the rotor of the motor 12 at every predetermined angular interval. A shift range switchover control circuit 42 is provided with a microcomputer 41, which counts both rising edge and falling edge of the A-phase signal and the B-phase signal outputted from the encoder 46. Further the microcomputer 41 rotationally drives the motor 12 by switching over the current supply phase of the motor 12 in a predetermined sequence based on the count value of the encoder 46, that is, encoder count value. It is possible to provide two systems, each including three-phase (U, V, W) coils of the motor 12 and a motor driver 37, so that, even when one system fails, the motor 12 is rotationally driven by the other system.

While the motor 12 is in rotation, the direction of rotation of the motor 12 is determined based on the order of generation of the A-phase signal and the B-phase signal. The encoder count value is counted up in a case of rotation in a normal direction (positive direction of rotation for switching over from P-range to Non-P-range). The encoder count value is counted down in a case of rotation in a reverse direction (negative direction of rotation for switching over from Non-P-range to P-range). Thus, even when the motor 12 is rotated in any one of the normal direction and the reverse direction, the relation of correspondence between the encoder count value and the rotation angle of the motor 12 is maintained. It is therefore possible to detect the rotation position of the motor 12 based on the encoder count value in any one of the normal rotation and the reverse rotation and rotationally drive the motor 12 by supplying electric current to a phase coil (U, V, W), which corresponds to the detected rotation position.

The shift range switchover control circuit 42 receives a signal indicating a shift lever operation position detected by a shift switch 44. The microcomputer 41 of the shift range switchover control circuit 42 thus switches over a target shift range in response to the shift lever operation or the like of a driver, switches over the shift range of the transmission 27 by rotationally driving the motor 12 in correspondence to the target shift range, and displays the actual shift range on a display unit 45 provided in an instrument panel (not shown) in the vehicle.

The shift range switchover control circuit 42 is supplied with a power supply voltage from a battery 50 (power source) mounted on the vehicle through a power supply relay 51. The power supply relay 51 is turned on and off by manually turning on and off an ignition (IG) switch 52 provided as a power supply switch. When the IG switch 52 is turned on, the power supply relay 51 is turned on to apply the power supply voltage to the shift range switchover control circuit 42. When the IG switch 52 is turned off, the power supply relay 51 is turned off to shut off power supply to the shift range switchover control circuit 42.

When a shift range switchover request is generated by a switchover of the target shift range in response to the shift lever operation of the driver, the microcomputer 41 of the shift range switchover control circuit 42 changes the target rotation position in response to the switchover of the target shift range. The microcomputer 41 switches over the shift range to the target shift range, that is, switches over the switchover position of the shift range switchover mechanism 11 to the target shift range position, by sequentially switching over the current supply phase of the motor 12 based on the encoder count value to rotationally drive the motor 12 to the target rotation position, which corresponds to the target shift range.

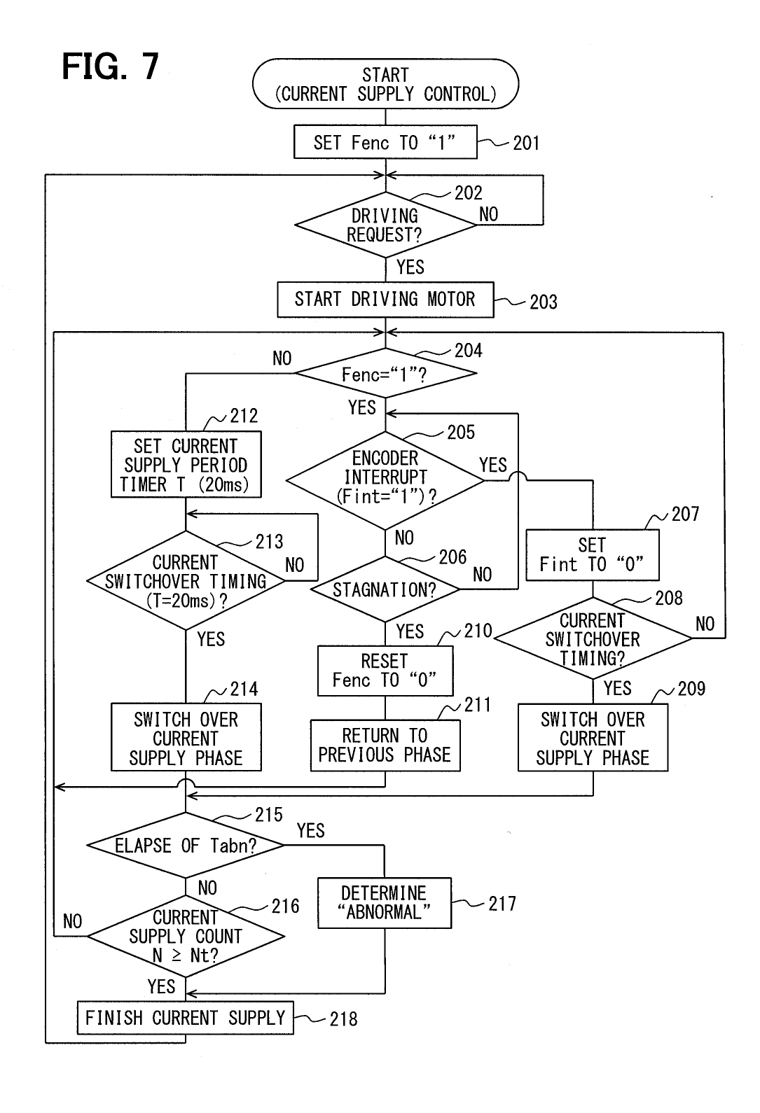

In the present embodiment, the microcomputer 41 of the shift range switchover control circuit 42 executes control routines shown in FIG. 6 and FIG. 7 to execute an encoder-synchronized control (rotation-synchronized control), which sequentially switches over the current supply phase of the motor 12 in synchronization with the output signal of the encoder 46 for rotationally driving the motor 12. In the encoder-synchronized control, by switching over the current supply phase of the motor 12 in synchronization with the output signal of the encoder 46 indicating the rotation position, the current supply phase is switched over at an appropriate time corresponding to the rotational position (rotation angle) of the motor and a driving torque, which is required to rotationally drive the motor 12 and larger than a load torque applied to the motor, is generated.

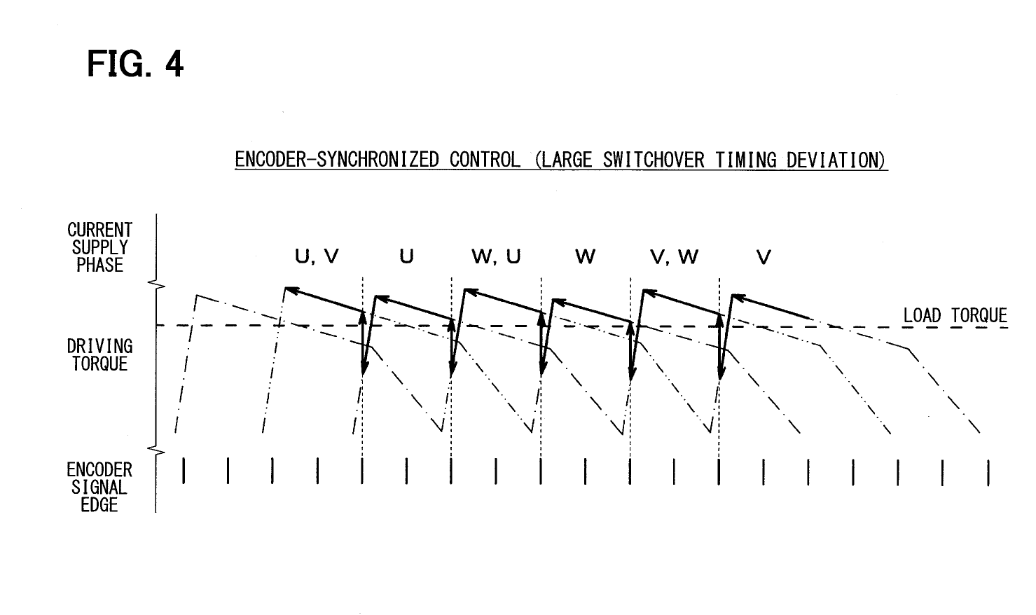

However the rotor rotation position of the motor 12 and the signal output time of the encoder 46 occasionally deviate from each other because of individual difference of the system (manufacturing tolerance), aging change and the like. In the encoder-synchronized control, a deviation of the switchover timing of the current supply phase increases as a deviation of the signal output timing of the encoder 46 relative to the rotor rotation position increases. As a result, it is likely that the driving torque of the motor 12 decreases to be smaller than the load torque as exemplified in FIG. 4. When the driving torque of the motor 12 decreases to be smaller than the load torque, the motor 12 cannot be rotationally driven, that is, the motor fails to rotate, thus resulting in stagnation of rotation of the motor 12. In the encoder-synchronized control, when the motor 12 cannot rotate because of stagnation, the output signal of the encoder 46 is not updated and the switchover of the current supply phase is stopped. Without the switchover of the current supply phase of the motor 12, it is not possible to rotationally drive the motor 12. As a result, reliability of the system operation is lowered.

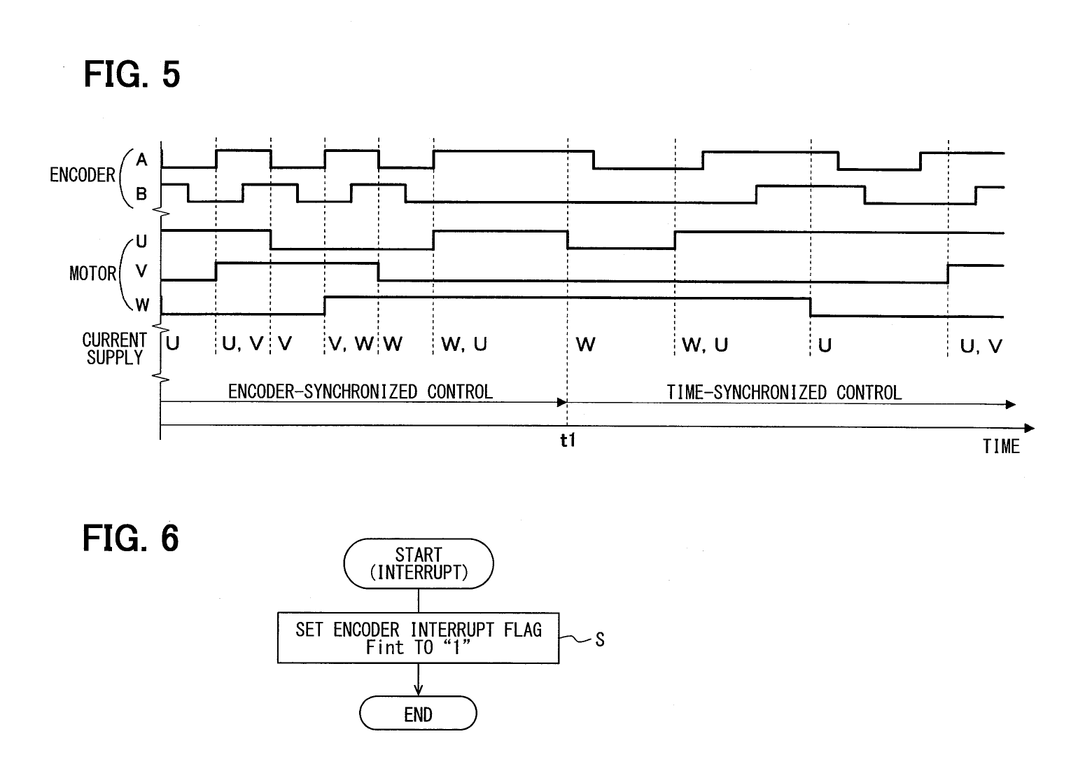

To counter this problem, the microcomputer 41 of the shift range switchover control circuit 42 executes the routine shown in FIG. 7 to perform the following control. More specifically, as shown in FIG. 5, the microcomputer 41 checks whether the rotation of the motor 12 is in stagnation after starting of the encoder-synchronized control, and switches over to a time-synchronized control, in which the current supply phase of the motor 12 is sequentially switched over at every predetermined time interval, at time t1 upon determination of the stagnation of motor rotation. Thus the motor 12 is rotationally driven by the time-synchronized control. As described above, when it is determined that the motor 12 fails to rotate after the start of the encoder-synchronized control, the control method is switched over from the encoder-synchronized control to the time-synchronized control. In the time-synchronized control, even when the output signal of the encoder 46 is not updated because of stagnation of rotation of the motor 12, the motor 12 is enabled to rotate by switching over the current supply phase at every predetermined interval by the time-synchronized control.

In a case that the rotation of the motor 12 stagnates after the start of the encoder-synchronized control because of a deviation of the switchover timing of the current supply phase, the stagnation is considered to arise because the switchover timing of the current supply phase is advanced too much, that is, too early, or retarded too much, that is, too late. In a case that the rotation of the motor 12 stagnates because of the advanced timing in switching over the current supply phase. In that case motor 12 can generate bigger torque with the previous current supply phase.

For this reason, as shown in FIG. 5, the control method is switched over from the encoder-synchronized control to the time-synchronized control at time t1, at which the current supply phase is W-phase and U-phase, by returning the current supply phase of the motor 12 to a previous current supply phase, that is, W-phase in FIG. 5, and starting the time-synchronized control from the W-phase in the present embodiment. The microcomputer 41 of the shift range switchover control circuit 42 executes the routines shown in FIG. 6 and FIG. 7.

### (Encoder Interrupt Routine)

The microcomputer 41 starts the encoder interrupt routine shown in FIG. 6 in synchronization with each of a rising edge and a falling edge of the A-phase signal and the B-phase signal of the encoder 46 during a period, in which the shift range switchover control circuit 42 is supplied with electric power. When this routine is started, the microcomputer 41 sets an encoder interrupt flag Fint to “1,” which indicates an interrupt for the encoder-synchronized current supply control, at step 101 and finishes this routine.

### (Current Supply Control Routine)

The microcomputer 41 starts the current supply control routine shown in FIG. 7 during a period, in which the shift range switchover control circuit 42 is supplied with electric power. This routine operates as a current supply control part. When this routine is started, the microcomputer 41 sets an encoder synchronization flag Fenc to “1” at step 201.

The microcomputer 41 then checks at step 202 whether a driving request (for example, shift range switchover request) for the motor 12 is present. When the driving request is not present, the microcomputer 41 repeats this step 202. When the driving request is present, the microcomputer 41 executes step 203 and starts rotationally driving the motor 12. The microcomputer 41 first supplies a current to a coil of a current supply phase, which corresponds to a present count value of the encoder 46, that is, rotation position of the motor 12.

The microcomputer 41 then checks at step 204 whether the encoder synchronization flag Fenc is “1”. When the encoder synchronization flag Fenc is “1,” the microcomputer 41 executes the encoder-synchronized control to rotationally drive the motor 12. The microcomputer 41 first checks at step 205 whether the encoder interrupt is present based on whether the encoder interrupt flag Fint is “1”. When the encoder interrupt is not present (that is, the encoder interrupt flag Fint is “0”), the microcomputer 41 checks at step 206 whether the rotation of the motor 12 is in stagnation by checking whether the encoder interrupt is not present for more than a predetermined stagnation threshold period (for example, 40 ms). This step 206 operates as a check part.

When the rotation of the motor 12 is not in stagnation, the microcomputer 41 repeats step 205 and its subsequent steps. When the encoder interrupt is present (that is, the encoder interrupt flag Fint is “1”), the microcomputer 41 resets the encoder flag Fint to “0”. The microcomputer 41 then checks at step 208 whether it is the timing of switchover of the current supply phase of the motor 12 by checking whether the number of the encoder interrupts after the previous switchover of the current supply phase reached a predetermined number.

When it is not the timing of switchover of the current supply phase, the microcomputer 41 repeats step 204 and its subsequent steps. When it is the timing of switchover of the current supply phase, the microcomputer 41 switches over the current supply phase of the motor 12 at step 209. The microcomputer 41 thus switches over the current supply phase of the motor 12 in synchronization with the output signal of the encoder 46.

When the motor 12 is in the stagnation at step 206, the microcomputer 41 determines that the motor 12 cannot be driven to rotate by the encoder-synchronized control and resets the encoder synchronization flag Fenc to “0” at step 210. The microcomputer 41 thus rotationally drives the motor 12 by switching over the control method from the encoder-synchronized control to the time-synchronized control.

In this case, the microcomputer 41 returns the current supply phase of the motor 12 to the previous current supply phase (last current supply phase) at step 211 and then repeats step 204. The microcomputer 41 determines at step 204 that the encoder synchronization flag Fenc is “0” and sets a current supply period timer T for measuring a current supply period to a predetermined period (for example, 20 ms) at step 212.

The microcomputer 41 then checks at step 213 whether it is the timing of switchover of the current supply phase of the motor 12 by checking whether the current supply period timer reached the predetermined period (that is, whether the current supply period of the current supply phase at present reached the predetermined period).

When it is the timing of switchover of the current supply phase, the microcomputer 41 switches over the current supply phase of the motor 12 at step 214. The microcomputer 41 thus switches over the current supply phase of the motor 12 at every predetermined interval.

After switching over the current supply phase of the motor 12 at step 209 or 214, the microcomputer 41 checks at step 215 whether a predetermined abnormality threshold period Tabn elapsed after the driving of the motor 12 has been started. When the abnormality threshold period Tabn does not elapse yet, the microcomputer 41 checks at step 216 whether a current supply counter N, which counts the number N of switchovers of the current supply phase after starting driving of the motor 12, reached a target current supply number Nt. When the current supply counter N does not reach the target current supply number Nt yet, the microcomputer 41 repeats step 204 and subsequent steps.

When the current supply counter N reaches the target current supply number Nt, the microcomputer 41 determines that the motor 12 has reached a target rotation position and finishes the current supply to the motor 12 at step 218. The microcomputer 41 thereafter repeats step 202 and subsequent steps.

When the abnormality threshold period Tabn elapses, the microcomputer 41 determines at step 217 that some abnormality continues to exist and finishes the current supply to the motor 12 at step 218. The microcomputer 41 thereafter repeats step 202 and subsequent steps.

In the present embodiment described above, the microcomputer 41 checks whether the rotation of the motor 12 is in the stagnation after the start of the encoder-synchronized control, and switches over the control method from the encoder-synchronized control to the time-synchronized control upon determination of the stagnation in the motor rotation. Thus, even when the motor 12 fails to rotate because of the deviation in the switchover timing of the current supply phase, that is, deviation in the signal output timing of the encoder 46, after starting of the encoder-synchronized control, the motor 12 is rotationally driven speedily by the time-synchronized control in place of the encoder-synchronized control and the reliability of the system operation is enhanced.

In addition, in the embodiment described above, the time-synchronized control is started after returning the current supply phase to the previous current supply phase of the motor 12 when the control method is switched over from the encoder-synchronized control to the time-synchronized control. As a result, even when the motor 12 fails to rotate because of early switchover timing of the current supply phase, the motor 12 is enabled to rotate by generation of the driving torque required for the motor rotation immediately after starting of the time-synchronized control.

It is however possible to start the time-synchronized control from the present current supply phase without returning to the previous current supply phase when the current supply method is switched over from the encoder-synchronized control to the time-synchronized control. In the embodiment described above, a part or all of the functions of the microcomputer 41 may be performed by hardware, for example, by one or plural integrated circuits.

In the embodiment described above, the shift range control apparatus is applied to the system, which includes the shift range switchover mechanism for switching over shift ranges between the P-range and the Non-P-range. However, the shift range control apparatus may alternatively be applied to a system, which includes a shift range switchover mechanism for switching over shift ranges among four shift ranges of the P-range, R-shift range, N-shift range and D-shift range. Further alternatively, the shift range switchover apparatus may be applied to a system, which includes a shift range switchover mechanism for switching over shift ranges among three, five or more shift ranges.

In addition, the shift range switchover apparatus may be applied to a system, which includes a range switchover mechanism for switching over shift ranges of a transmission (reduction device) of an electric vehicle, which is other than the automatic transmission (AT, CVT, DCT and the like).

What is claimed is:

1. A shift range switchover control apparatus for a transmission of a vehicle, the shift range switchover control apparatus comprising:
a shift range switchover mechanism including a motor as a driving power source for switching over a shift range of the transmission;
an encoder for outputting a pulse signal in synchronization with a rotation of the motor;
a power supply control part for rotationally driving the motor by executing an encoder-synchronized control to sequentially switch over a current supply phase of the motor in synchronization with an output signal of the encoder; and
a check part for checking whether the motor is in stagnation in rotation after a start of the encoder-synchronized control,
wherein the power supply control part rotationally drives the motor by switching over from the encoder-synchronized control to a time-synchronized control to sequentially switch over the current supply phase of the motor in synchronization with a predetermined time, when the check part determines that the motor is in the stagnation.

2. The shift range switchover control apparatus according to claim 1, wherein:
the power supply control part starts the time-synchronized control by returning a current supply phase of the motor to a previous current supply phase, to which the current was supplied last, at time of switching over from the encoder-synchronized control to the time-synchronized control.
